(19) United States
(12) Patent Application Publication
(10) Pub. No.: US 2002/0047630 A1
(43) Pub. Date: Apr. 25, 2002

(54) Gas-discharge lamp having brightness control

(76) Inventor: Mark A. Kastner, New Berlin, WI (US)

Correspondence Address: Casimir F. Laska, Michael Best & Friedrich LLP, 100 East Wisconsin Avenue, Milwaukee, WI, 53202-4108, US

(21) Appl. No.: 09/870,347

(22) Filed: May 30, 2001

Related U.S. Application Data
(60) Provisional application No. 60/208,518, filed on Jun. 1, 2000.

(51) Int. Cl. G05F 1/00

(52) U.S. Cl. 315/291; 315/DIG. 4

(57) ABSTRACT

A gas-discharge lamp and method of operating the lamp for controlling the brightness of the lamp. The lamp includes a drive for supplying a varying signal in response to receiving first and second control signals. The method includes generating the first and second control signals for a time period. The generating of the first and second control signals includes, for a first interval of the time period, generating the first control signal having a first duty cycle, and generating the second control signal having a second duty cycle. The generating of the first and second control signals further includes, for a second interval of the time period, generating the first control signal having a third duty cycle and generating the second control signal having a fourth duty cycle. The third duty cycle is less than the first duty cycle, and the fourth duty cycle is less than the second duty cycle.

### RELATED APPLICATION

This application claims priority to U.S. Provisional Patent Application No. 60/208,518, entitled RAMPED DUTY CYCLE DIMMING, filed Jun. 1, 2000.

### BACKGROUND OF THE INVENTION

The invention relates to a gas-discharge lamp having brightness control, and particularly to a gas-discharge lamp including a circuit that provides duty-cycle shifting for brightness control.

It is desirable to control the intensity of a neon sign or other gas-discharge lamp application. This requires some sort of variable power source to drive the lamp. Neon power sources are typically one of two types: a neon transformer, or a neon power supply. A neon transformer steps up the utility voltage, and drives the neon lamps at utility frequency (50 or 60 Hz). A neon power supply rectifies the line voltage to form DC rail voltages, inverts the rail voltages at relatively high frequency (typically 20-100 kHz), and drives a small step up transformer that drives the tube. The present invention deals with a neon power supply.

Numerous methods have been used in an attempt to dim a neon lamp powered from a neon power supply. Some methods attempt to reduce the energy delivered to the tube on a continuous basis. One method includes reducing the DC rail voltages to the inverter. This and similar methods suffer from a common disadvantage; when dimmed, the center of large neon signs becomes dimmer than the sections electrically close to the incoming power. This is thought to result from capacitive losses along the length of the gas discharge tube.

One dimming method that gives the greatest range of dimming, with no significant difference in intensity along the length of the tube, is pulse group modulation (PGM, refer to FIG. 1). For PGM, the inverter is operated at full input voltage and optimum frequency (e.g., 20 kHz) for a first interval 15 of a time period 5 (i.e., a first group of pulses 10 is generated for a first interval 15). The inverter is then “shut off” for a second interval 25 of the time period 5 (i.e., no group of pulses 20 is generated in the second interval 25). The result is groups of drive pulses being delivered to the transformer and to the tube load. The on and off pulsing is continuously performed at a sufficiently high repetition rate to prevent the perception of flickering (about 100-200 Hz). The overall repetition rate is kept constant, while the lengths of the first and second intervals 15 and 25 are varied to implement dimming. The lamp is at full intensity when the ON interval 15 occupies the entire time period 5, and the lamp is off when the OFF interval 25 occupies the entire time period 5. In between lies a smooth range of dimming from off to fully bright. For a 200 Hz repetition rate and a 20 kHz drive frequency, it is possible to achieve 100 brightness steps, with good visual performance at all steps.

Pulse group modulation suffers from one major drawback. The step-up transformer oscillates at the pulse group repetition rate, producing a loud, annoying buzz. A subtler drawback of PGM dimming is that at lower brightness levels, the tube may extinguish and re-ignite with each pulse group. This continuous re-ionization generates radiation EMI.

One prior art method used to combat the above problems is frequency shift key (FSK) dimming (see FIG. 2). FSK dimming entails producing a first group of pulses 35 for a first interval 40 of a time period 45 (referred to as the “on” portion or mode), ramping to a higher pulse frequency during a second interval 55, producing a second group of pulses 60 for a third interval 65 (referred to as the “off” portion or mode), and ramping down to the frequency of the first group of pulses 35 in a fourth interval 75. The transformer and tube are continuously driven, but with a much lower energy transfer efficiency during the “off” portion 60. By varying the amount of time spent in the normal high efficiency “on” mode 45 and the low efficiency “off” mode 55, the sign can be progressively dimmed. Also, since the transformer is continuously driven, the audible noise generated by the pulse group repetition is dramatically reduced.

FSK dimming suffers from one major drawback. The continuously changing drive frequencies generate a wide spectrum of electromagnetic interference (EMI) noise, making EMI filtering difficult. However, since FSK dimming continuously drives the tube, it is always ignited, and re-ignition radiated EMI is not a concern.

### SUMMARY OF THE INVENTION

Accordingly, in one embodiment, the invention provides a gas-discharge lamp connectable to a power source and to a gas-discharge tube for controlling brightness of the tube. The lamp includes a drive that receives direct current (DC) power, receives first and second control signals, and inverts the DC power to create a first varying signal in response to the first and second control signals. The lamp further includes a transformer interconnected to the drive that transforms the first varying signal to a second varying signal; the second varying signal is supplied to the tube. The lamp further includes a controller interconnected to the drive. The controller generates the first and second control signals for a time period including, for a first interval of the time period, generating the first control signal with a first duty cycle and generating the second control signal with a second duty cycle, and, for a second interval of the time period, generating the first control signal with a third duty cycle and generating the second control signal with a fourth duty cycle. The third duty cycle is less than the first duty cycle, and the fourth duty cycle is less than the second duty cycle. The generation of the first and second control signals just described is referred to herein as duty-cycle shifting (DCS).

The invention also provides a method of controlling the brightness of a gas-discharge lamp including a power supply having a drive. The drive supplies a varying signal in response to receiving first and second control signals. The method includes establishing a time period, and generating the first and second control signals for the time period. The generating of the first and second control signals includes, for a first interval of the time period, generating the first control signal having a first duty cycle and generating the second control signal having a second duty cycle, and, for a second interval of the time period, generating the first control signal having a third duty cycle and generating the second control signal having a fourth duty cycle. The third duty cycle is less than the first duty cycle, and the fourth duty cycle is less than the second duty cycle. The method further includes providing the first and second control signals to the drive.

Duty-cycle shifting, like pulse group modulation, shares the advantage of a very large dynamic range. The neon sign can be dimmed from full brightness down to a very low intensity. This is accomplished without some of the undesirable effects of prior art dimming methods. For example, duty-cycle shifting prevents uneven dimming along the length of the tube, and prevents extinguishing or de-ionization of the tube. Other features and advantages of the invention will become apparent to those skilled in the art upon review of the following detailed description, claims, and drawings.

### BRIEF DESCRIPTION OF THE DRAWINGS

FIG. 1 is a schematic diagram representing the prior art pulse group modulation control of a gas-discharge lamp power supply.

FIG. 2 is a schematic diagram representing the prior art frequency-shift-key dimming control for a gas-discharge lamp power supply.

FIG. 3 is a schematic representation of a gas-discharge lamp of the invention.

FIG. 4 is a schematic diagram representing duty-cycle shifting and duty-cycle transition for a gas-discharge lamp power supply.

FIG. 5 is a schematic diagram representing first and second control signals having a balanced duty cycle.

FIG. 6 is a schematic diagram representing first and second control signals having an unbalanced duty cycle.

FIG. 7 is a schematic diagram representing first and second control signals reducing from a first duty cycle to a third duty cycle and a second duty cycle to a fourth duty cycle.

FIG. 8 is a schematic diagram representing first and second control signals increasing from a third duty cycle to a first duty cycle and a fourth duty cycle to a second duty cycle.

FIG. 9 is a schematic diagram representing first and second control signals during separate time intervals.

Before any embodiments of the invention are explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

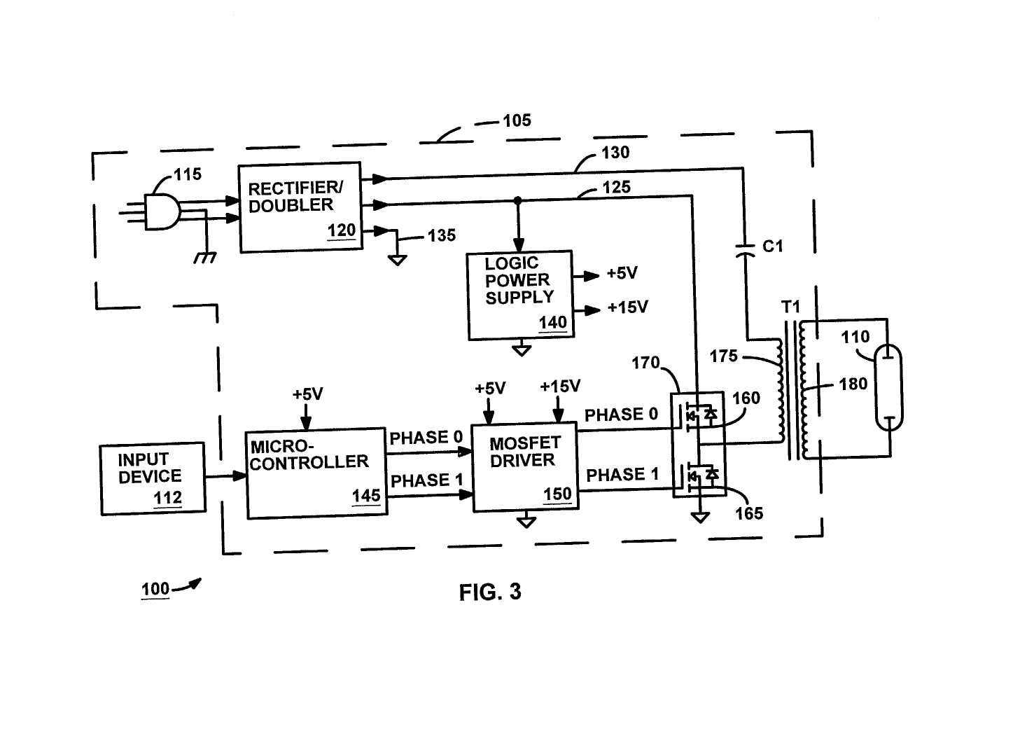

A gas-discharge lamp 100 of the invention is schematically shown in FIG. 3 Although the description herein is for a neon sign, other gas-discharge lamps or gas-discharge signs may be used with the invention. The gas-discharge lamp 100 of the invention generally includes a power supply 105, a load 110, and an input device 112.

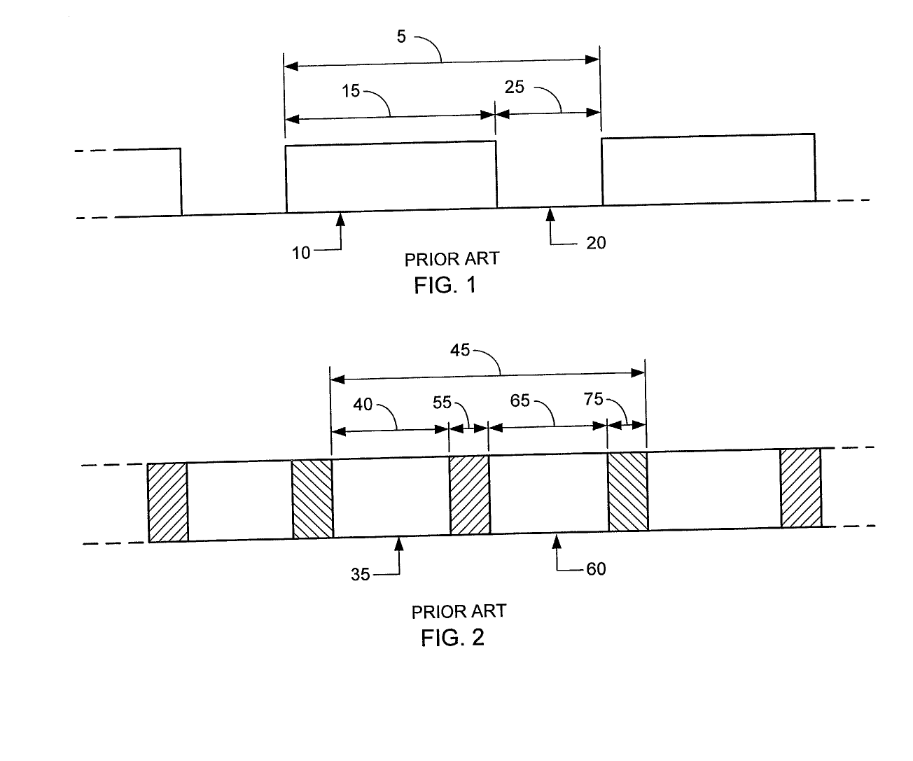

As shown in FIG. 1, the power supply 105 includes a plug 115 that connects to a power source. The power source may be a 120-volt, alternating current (VAC) power source or a 240-VAC power source. The power from the power source is provided to a rectifier/doubler circuit 120, which is well known in the art. The power from the power source is rectified and doubled (if a 120-VAC source) to form a high-voltage rail 125 (e.g., 340-VDC), an intermediate-voltage rail 130 (e.g., 170-VDC), and low-voltage rail 135 (e.g., 0-VDC). Although a rectifier/doubler circuit 120 is shown, for 240-VAC applications, only a bridge rectifier is required. Further, the voltages of the high-voltage, intermediate-voltage, and low-voltage rails 125, 130 and 135 may vary.

A logic power supply 140 is electrically interconnected to the high-voltage rail 125, and creates one or more bias-voltages (e.g., a 5-VDC low-bias voltage, and/or a 15-VDC high-bias voltage) for powering logic components. The logic components include a microcontroller 145 and a MOSFET driver 150 for driving first and second MOSFETs 160 and 165. The microcontroller 145 (also referred to herein as the “controller”) includes a processor and a memory. The memory includes one or more software modules having instructions. The processor retrieves, interprets, and executes the instructions to control the MOSFET driver 150 for driving the load 110. The contents of the software instructions will become apparent in the description below. The microcontroller 145 generates control signals for driving or controlling MOSFETs 160 and 165. The control signals include a first control signal phase0 and a second control signal phase1. The first and second control signals phase0 and phase1 are transformed by the MOSFET driver 150 to an increased voltage for controlling the MOSFETs 160 and 165. That is, the control signals phase0 and phase1 are provided from the microcontroller 145 to the MOSFET driver 150, which generates drive signals phase0 and phase1 having an increased voltage for controlling the first and second MOSFETS 160 and 165.

The first and second MOSFETs 160 and 165 are connected in a half H-bridge configuration (also referred to as a power MOSFET half-bridge drive 170). The first MOSFET 160 is connected to the high-voltage rail 125, the bridge center is connected to a primary side 175 of a transformer T1, and the second MOSFET 165 is connected to the low-voltage rail 135 (also referred to as circuit common). The other end of primary winding 175 of transformer T1 is connected to a resonant capacitor C1, which is connected to the intermediate rail 130. The capacitor C1 and the primary winding 175 create an RC resonant circuit. The power MOSFET half-bridge drive 170 drives the transformer T1 with a varying signal (e.g., an AC signal with a DC offset) at a desired output frequency. The signal at the primary winding 175 is reflected at a secondary winding 180 with a desired output voltage. The components of the power supply 105 are well-known to one of ordinary skill in the art, and may be implemented using discrete circuitry, integrated circuitry, and a microprocessor and memory.

The load 110 includes at least one gas-tube interconnected with the secondary winding 180 of the transformer T1. For the embodiment shown, the load 110 is a single neon tube driven by the power supply 105 at a voltage and a frequency. The voltage and frequency applied to the load 110 varies depending on the frequency applied by the power MOSFET half-bridge circuit to the RC circuit.

The input device 112 provides an interface allowing an operator to control the lamp 100, including entering a desired lamp brightness level. The input device may further allow the operator to enter other commands such as lamp flashing, lamp fading, and similar features. Example input devices 112 include trim knobs, push buttons (including keyboards and keypads), switches, and other similar input devices.

In operation, an operator activates the lamp by inserting the plug 115 into the power source and turning a master switch ON. Upon activation, power provided by the power source is rectified (and doubled) by the rectifier/doubler 120. The rectified power is provided to logic power supply 140, which generates the low and high bias voltages. The microcontroller 145 receives the low bias voltage, and initializes the processor and memory. Upon initializing the processor, the one or more software modules are recalled from memory. The processor interprets and executes instructions of the one or more software modules, resulting in the microcontroller generating control signals phase0 and phase1 (discussed further below). The control signals phase0 and phase1 are provided to the MOSFET driver 150, and the driver 150 controls the first and second MOSFETs 160 and 165 in response thereto. The MOSFET driver 150 generates drive signals phase0 and phase1. The drive signals phase0 and phase1 have a relationship (i.e., an increased voltage) to the control signals phase0 and phase1 generated by the microcontroller 145. Thus, the first and second drive signals phase0 and phase1 are essentially the same as the first and second control signals phase0 and phase1, and may also be referred to as the first and second control signals phase0 and phase1. The signals phase0 and phase1 are provided to the power half-bridge drive 170, resulting in a first varying signal. The first varying signal is provided to primary winding 175 and is transferred to the secondary winding 180. The transferred signal results in a second varying signal having a desired root-mean-square (RMS) voltage and a desired frequency. As is known in the art, the RMS voltage and frequency provided to the load is based in part on, or has a relationship to, the control signals phase0 and phase1 generated by the microcontroller 145. For the embodiment shown, the signals phase0 and phase1 are determined by the one or more software modules stored in memory.

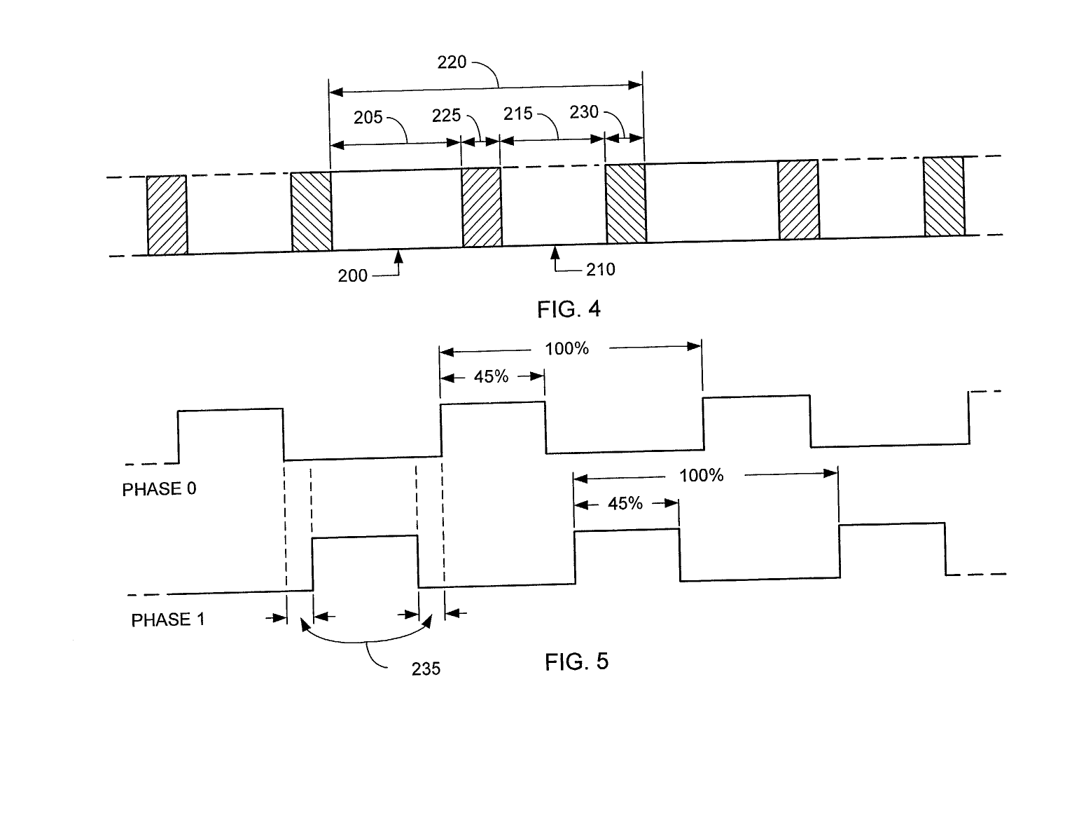

The software modules of the invention use duty-cycle shifting for controlling the intensity of the lamp. As schematically shown in FIG. 4, for duty-cycle shifting (DCS), the drive 170 is operated at full input voltage, optimum frequency, and full-duty cycle (e.g., a ninety percent to one hundred percent duty cycle) for a first interval of a time period, and then operated at full input voltage, optimum frequency, and low-duty cycle (e.g., one percent to ten percent duty cycle) for a second interval of the time period. That is, a first group of pulses 200 having a full-duty cycle is generated for a first time interval 205, and then a second group of pulses 210 having a low-duty cycle is generated for a second time interval 215. The first interval is referred to as an “on” portion or mode, and the second interval is referred to as an “off” portion or mode. The “on” and “off” pulsing is referred to as duty-cycle shifting because the duty cycle is shifted from a first duty cycle to a second duty cycle and vice-versa. Although the description and drawings herein have the second interval being after the first interval, one skilled in the art will realize that the first interval may be after the second interval. In other words, the drive may be operated at full input voltage, optimum frequency, and low-duty cycle for an initial interval of the time period, and then operated at full input voltage, optimum frequency, and full-duty cycle for a later interval of the time period. The pulsing is continuously performed at a sufficiently high repetition rate to prevent the perception of flickering (about 100-200 Hz.). The repetition rate of the DCS signal sets the time period (also referred to as the repetition period 220) of the signal, and the lengths of the first and second intervals 205 and 215 are varied to implement dimming control. The lamp is at full intensity when the “on” interval 205 occupies the entire repetition period 220 and the lamp is at its lowest intensity when the “off” period interval 215 occupies the entire time period.

DCS provides a dynamic range for the operator to set. The range is determined in part by the duty-cycle of the “on” mode and the duty cycle of the “off” mode. The lamp can be dimmed from full brightness down to a very low intensity. However, because the “off” mode still applies a varying signal to the tube 110, the tube 110 does not de-ionize or extinguish during the “off” mode. The result is that some minimum amount of energy is continuously delivered to the tube load, which helps prevent it from de-ionizing. Since the re-ionizing of the tube causes a large voltage spike on the tube, it can be a significant source of EMI. Thus, unlike PGM, EMI noise is reduced due to the tube 110 not re-ionizing during each “on” portion. In other words, the tube is continuously driven, eliminating the problem of re-ignition radiated EMI noise.

In the embodiment shown, the first group of pulses 200 are driven at an optimum or “on” duty cycle, where the “on” duty cycle is substantially close to one hundred percent, and the second group of pulses are driving at a minimum or “off” duty cycle, where the “off” duty cycle is substantially close to zero percent. However, it is envisioned that the duty cycles during the “on” and “off” intervals may vary.

In addition to using DCS, the software modules of the invention use duty-cycle transitioning (may be referred to as “duty-cycle ramping”) for controllably changing or transitioning the output duty cycle of the inverter. In duty-cycle transitioning (DCT), the duty cycle changes from a first duty cycle to a second duty cycle. The transitioning occurs over a time interval, rather than occurring abruptly. The transitioning from the first duty cycle to the second duty cycle may be in a linear or non-linear manner.

Referring again to FIG. 4, during a third time interval 225, the duty cycle of the signal supplied to the transformer T1 is controllably transitioned from the “on” duty cycle to the “off” duty. In one embodiment, the length of the third interval 225 is fixed and is approximately ten percent of the repetition period. During a fourth interval 230, the duty cycle of the signal supplied to the transformer T2 is controllably transitioned from the “off” duty cycle to the “on” duty cycle. In one embodiment, the length of the fourth interval 230 is fixed and is approximately ten percent of the repetition period. The transitioning of the duty cycle and constant frequency operation allows the transformer to operate at very low audible noise levels, while providing great brightness control performance. Although the description and drawings herein have the third interval being after the first interval and the fourth interval being after the second interval, one skilled in the art will realize that the location of the third and fourth intervals may vary.

The optimum waveform to excite mercury-argon tubes is a balanced drive, where the duty cycle of phase0 and phase1 are the same. A balance drive prevents mercury migration in a mercury tube. FIG. 5 shows the control signals phase0 and phase1 during the “on” interval 200. As schematically shown in FIG. 5, the control signal phase0, which controls MOSFET 160, has a duty cycle of approximately forty-five percent, and the control signal phase1, which controls MOSFET 165, has a duty cycle of approximately forty-five percent. These two signals result in the drive 170 generating a varying signal having a duty cycle of approximately ninety percent. The varying signal generated by the drive 170 has a frequency (e.g., 20-100 kHz) substantially larger than the repetition rate (e.g., 100-200 Hz). In addition, for the embodiment shown, the signals phase0 and phase1 include off-periods 235 allowing each MOSFET 160 and 165 to properly prevent current flow before the other MOSFET 160 or 165 allows current flow. Using optimal dead bands 235 reduces MOSFET heating by virtually eliminating cross-conduction energy that must be absorbed by the MOSFETs 160 and 165. Conversely, the prior art dimming scheme typically require that the power MOSFETs run with non-optimum heating one hundred percent of the time generating excessive heat.

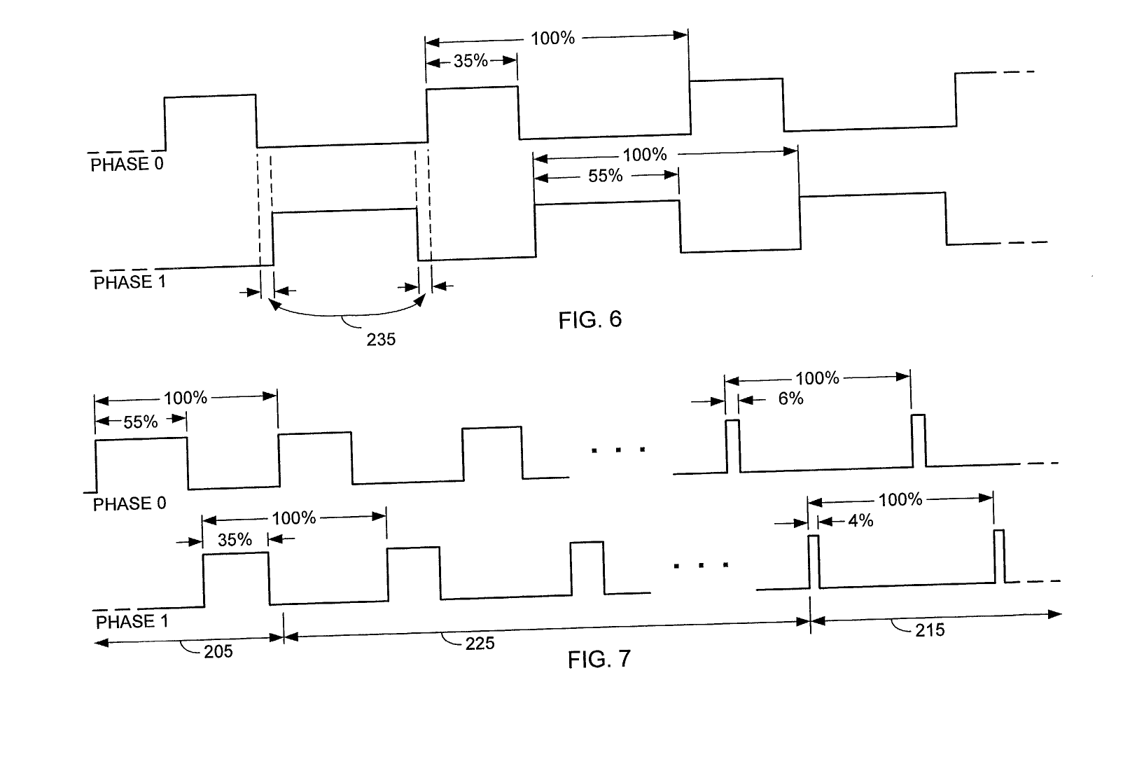

Unlike mercury-argon tubes, a balanced drive for a neon tube causes the neon tubes to form plasma bubbles. One method for preventing plasma bubbles is to generate an offset varying drive signal with the drive 170. As schematically shown in FIG. 6, the signal phase0, which controls MOSFET 160, has a duty cycle of approximately thirty-five percent, and the signal phase1, which controls MOSFET 165, has a duty cycle of approximately fifty-five percent. The signals phase0 and phase1 shown in FIG. 6 result in the drive 170 generating a varying signal having a duty cycle of approximately ninety percent. In addition to preventing plasma bubbles, the polarity of the offset drive may be periodically reversed to prevent mercury migration.

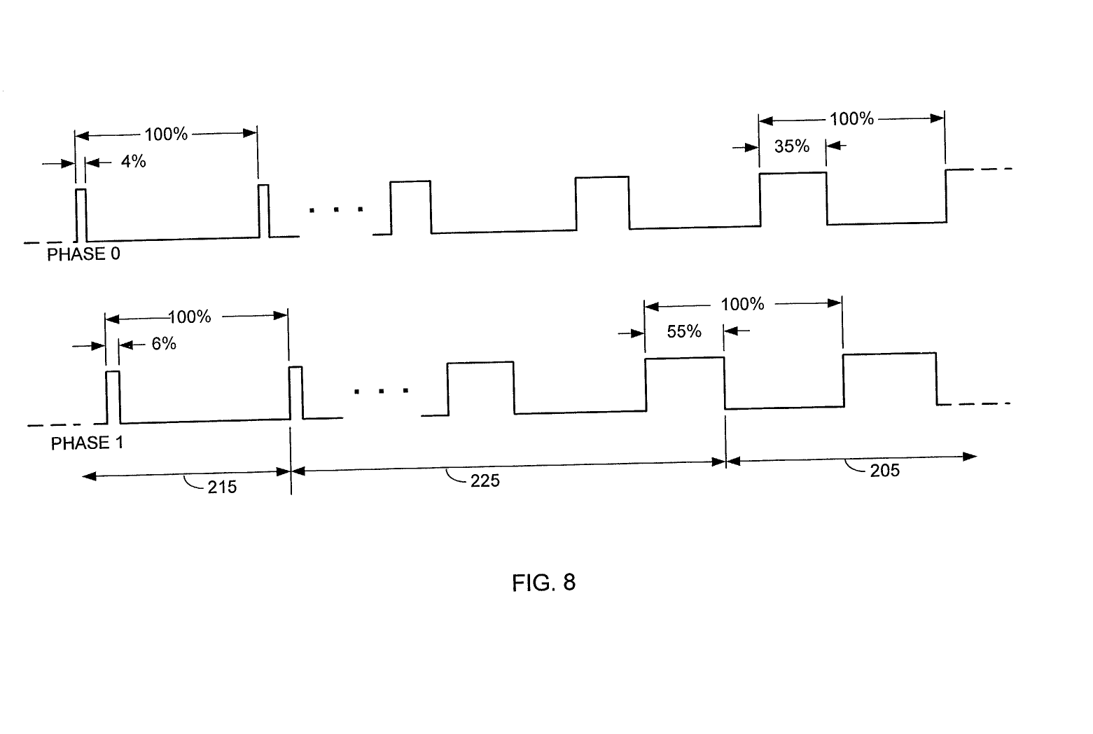

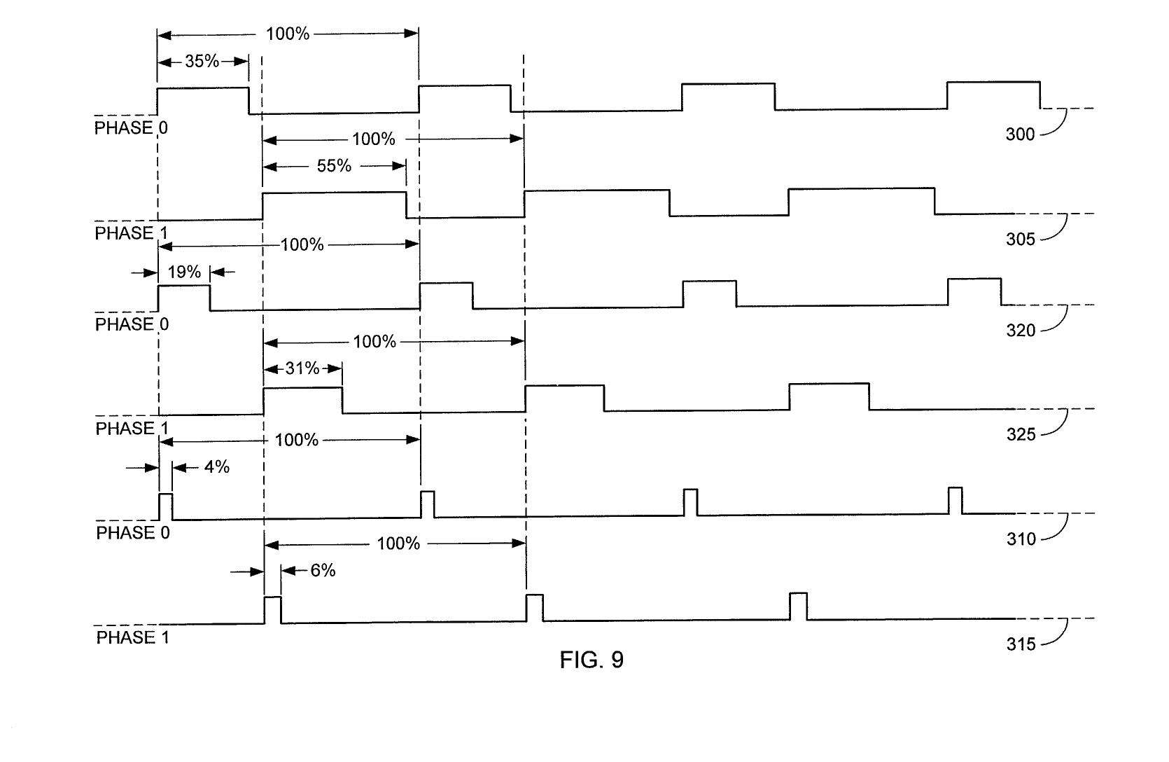

In one embodiment of DCS, the ratio in phase0 and phase1 duty cycles (e.g., thirty-five percent and fifty-five percent) is maintained through the “off” period. This allows the minimum possible disruption in the drive timing, and thereby minimizes emitted audible noise. For a specific example and referring to FIG. 7, the signal phase0 is controllably transitioned from thirty-five percent to four percent and the signal phase1 is controllably transitioned from fifty-five percent to six percent. These two signals result in the drive 170 generating a varying signal that transition from ninety percent to ten percent. Referring to FIG. 8, the signal phase is controllably transitioned from four percent to thirty-five percent and the control signal phase1 is controllably transitioned from six percent to fifty-five percent. These two signals result in the drive 170 generating a varying signal that transition from a ten percent duty cycle to a ninety percent duty cycle. FIG. 9 overlaps the phase0 and phase1 control signals at three different locations in the repetition period 220. The lines 300 and 305 show offset control signals phase0 and phase1 during the first interval 205. The lines 310 and 315 show offset control signals phase0 and phase1 during the second interval 215. The lines 320 and 325 show offset control signals mid-way through either the third or fourth intervals 225 or 230. Transitioning the shifting of the duty cycles results in an audibly quieter lamp than straight PGM. Rather that suddenly being started and stopped, the waveform is slowly ramped on and off at the beginning and end of pulse groups.

Although the changing waveforms are generated with a microcontroller 145 having a processor executing software instructions, other microcontrollers (e.g., integrated circuits) may be used. In addition, other options of manipulating the output waveform are possible. For example, as the unit is gradually brightened, it remains in DCS up until the step right before full intensity. At that point, it switches to constant duty cycle mode, which allows the lamp 100 to maximize the output intensity. This substantially eliminates all audible noise, since there is no longer any dimming frequency present. In another embodiment, to achieve maximum brightness, it may be desirable to eliminate the transition interval at the highest brightness level. In addition, the software modules may include software instructions for implementing other optional features, such as fading, and flashing.

DCS intensity control is very suitable for variable dimming. The inventor has determined that it is possible to have over one hundred dimming steps. FSK dimming requires a longer frequency transition interval than the duty cycle transition interval required by DCS. The result is a reduction in dimming range. Thus, DCS has a greater dynamic range than FSK dimming.

As can be seen from the above, the invention provides a new and useful gas-discharge lamp having brightness control. Various features and advantages of the invention are set forth in the following claims.

What is claimed is:

1. A method of controlling the brightness of a gas-discharge lamp including a power supply having a drive, the drive supplying a varying signal in response to first and second control signals, the method comprising:
establishing a time period;
generating the first and second control signals for the time period including,
for a first interval of the time period, generating the first control signal having a first duty cycle, and generating the second control signal having a second duty cycle;
for a second interval of the time period, generating the first control signal having a third duty cycle, the third duty cycle being less than the first duty cycle, and generating the second control signal having a fourth duty cycle, the fourth duty cycle being less than the second duty cycle; and
providing the first and second control signals to the drive.

2. A method as set forth in claim 1 wherein the first duty cycle is substantially greater than the third duty cycle, and wherein the second duty cycle is substantially greater than the fourth duty cycle.

3. A method as set forth in claim 1 wherein the first and second duty cycles are approximately the same, and wherein the third and fourth duty cycles are approximately the same.

4. A method as set forth in claim 1 and further comprising:
determining a lamp brightness; and
determining a length of the first and second intervals corresponding to the lamp brightness.

5. A method as set forth in claim 4 and further comprising:
continuously repeating the generating of the first and second control signals for the determined lamp brightness.

6. A method as set forth in claim 1 wherein the generating of the first and second control signals for the time period further includes:
for a third interval of the time period, transitioning the duty cycle of the first control signal, and transitioning the duty cycle of the second control signal.

7. A method as set forth in claim 6 wherein the transitioning of the duty cycles of the first and second control signals, respectively, include reducing the duty cycle of the first control signal from the first duty cycle to the third duty cycle and reducing the duty cycle of the second control signal from the second duty cycle to the fourth duty cycle.

8. A method as set forth in claim 6 wherein the transitioning of the duty cycles of the first and second control signals, respectively, include increasing the duty cycle of the first control signal from the third duty cycle to the first duty cycle and increasing the duty cycle of the second control signal from the fourth duty cycle to the second duty cycle.

9. A method as set forth in claim 1 wherein the generating of the first and second control signals for the time period further includes:
for a third interval of the time period, reducing the duty cycle of the first control signal from the first duty cycle to the third duty cycle and reducing the duty cycle of the second control signal from the second duty cycle to the fourth duty cycle; and
for a fourth interval of the time period, increasing the duty cycle of the first control signal from the third duty cycle to the first duty cycle and increasing the duty cycle of the second control signal from the fourth duty cycle to the second duty cycle.

10. A method as set forth in claim 9 wherein the reducing and increasing of the duty cycles is performed linearly.

11. A method as set forth in claim 4 and further comprising:
determining a second lamp brightness; and
determining the first and second intervals corresponding to the second lamp brightness.

12. A gas-discharge lamp connectable to a power source and to a gas-discharge tube for controlling a brightness of the tube, the lamp comprising:
a drive that receives direct current (DC) power, receives first and second control signals, and inverts the DC power to create a first varying signal in response to the first and second control signals;
a transformer interconnected to the drive that transforms the first varying signal to a second varying signal, the second varying signal being supplied to the tube,
a controller interconnected to the drive, the controller generating the first and second control signals for a time period including
for a first interval of the time period, generating the first control signal having a first duty cycle, and generating the second control signal having a second duty cycle, and
for a second interval of the time period, generating the first control signal having a third duty cycle, the third duty cycle being less than the first duty cycle, and generating the second control signal having a fourth duty cycle, the fourth duty cycle being less than the second duty cycle.

13. A lamp as set forth in claim 12 and further comprising:
a rectifier interconnectable to the power source, the rectifier being operable to receive alternating current (AC) power from the power source and rectifying the AC power to DC power.

14. A lamp as set forth in claim 12 wherein the drive includes first and second metal-oxide-semiconductor-field-effect transistors (MOSFET) connected in a half H-bridge configuration.

15. A lamp as set forth in claim 12 wherein the controller includes a processor and memory, the memory having one or more software modules executable by the processor.

16. A lamp as set forth in claim 12 wherein the first duty cycle is substantially greater than the third duty cycle, and wherein the second duty cycle is substantially greater than the fourth duty cycle.

17. A lamp as set forth in claim 12 wherein the first and second duty cycles are approximately the same, and wherein the third and fourth duty cycles are approximately the same.

18. A lamp as set forth in claim 12 and further comprising:
an input device operable to receive a desired lamp brightness from an operator; and
wherein the controller determines a length of the first and second intervals corresponding to the first lamp brightness.

19. A lamp as set forth in claim 12 wherein the controller generates the first and second control signals for the time period including:
for a third interval of the time period, transitioning the duty cycle of the first control signal, and transitioning the duty cycle of the second control signal.

20. A lamp as set forth in claim 19 wherein the transitioning of the duty cycles of the first and second control signals, respectively, include reducing the duty cycle of the first control signal from the first duty cycle to the third duty cycle and reducing the duty cycle of the second control signal from the second duty cycle to the fourth duty cycle.

21. A lamp as set forth in claim 19 wherein the transitioning of the duty cycles of the first and second control signals, respectively, include increasing the duty cycle of the first control signal from the third duty cycle to the first duty cycle and increasing the duty cycle of the second control signal from the fourth duty cycle to the second duty cycle.

22. A lamp as set forth in claim 1 wherein the controller generates the first and second control signals for the time period including:
for a third interval of the time period, reducing the duty cycle of the first control signal from the first duty cycle to the third duty cycle and reducing the duty cycle of the second control signal from the second duty cycle to the fourth duty cycle; and
for a fourth interval of the time period, increasing the duty cycle of the first control signal from the third duty cycle to the first duty cycle and increasing the duty cycle of the second control signal from the fourth duty cycle to the second duty cycle.

23. A method as set forth in claim 22 wherein the reducing and increasing of the duty cycles is performed linearly.
